(19) United States
(12) Patent Application Publication
(10) Pub. No.: US 2014/0119017 A1
(43) Pub. Date: May 1, 2014

(54) LIGHT SOURCE MODULE INCORPORATING LASER LIGHT SOURCE

(71) Applicant: HON HAI PRECISION INDUSTRY CO., LTD., New Taipei (TW)

(72) Inventor: KAI-WEN WU, New Taipei (TW)

(73) Assignee: HON HAI PRECISION INDUSTRY CO., LTD., New Taipei (TW)

(21) Appl. No.: 13/971,861

(22) Filed: Aug. 21, 2013

(30) Foreign Application Priority Data
Oct. 29, 2012 (TW) 101139875

(51) Int. Cl. F21V 13/04

(52) U.S. Cl. CPC F21V 13/04
USPC 362/259

(57) ABSTRACT

A light source module includes a laser light source, and an optical lens facing the laser light source. The optical lens includes a first light reflecting face, a second light reflecting face facing the first light reflecting face, a light incident face connecting the first light reflecting face and the second light reflecting face, and a light emitting face opposite to the light incident face. Light emitted from the laser light source is firstly reflected to the second reflecting face by the first reflecting face, then reflected to the light incident face by the second reflecting face, and then entered into the optical lens from the light incident face, and transmitted in the optical lens, finally exited from the light emitting face.

### BACKGROUND

1. Technical Field

The present disclosure relates generally to a light source module, and more particularly to a light source module which incorporates a laser light source.

2. Description of Related Art

LEDs (light emitting diode) have been widely promoted as light sources of electronic devices owing to many advantages, such as high luminosity, low operational voltage and low power consumption. However, during operation of the LED, the LED converts the power into optical energy, also converts into heat energy. Thus, the photoelectric conversion efficiency of the LED is not high. Laser diodes have a photoelectric conversion efficiency which is higher than LEDs.

Generally, a conventional laser projection device includes a laser light source having at least a laser diode, a spectroscope arranged on the light path of the laser diode and a photoelectric conversion device. Light emitted from the laser diode directly radiates to the spectroscope and then is reflected by the spectroscope to mix. And then, the mixed light can be modulated into images on a screen by the photoelectric conversion device. However, a height of the laser diode is low and the light emitted from the laser diode is hardly to transmitted into the spectroscope in a suitable angle.

What is needed, therefore, is a light source module capable of overcoming the above described disadvantages.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 shows a cross-sectional view of a light source module in accordance with a first embodiment of the present disclosure.

FIG. 2 shows a cross-sectional view of a light source module in accordance with a second embodiment of the present disclosure.

### DETAILED DESCRIPTION

Embodiments of a light source module will now be described in detail below and with reference to the drawings.

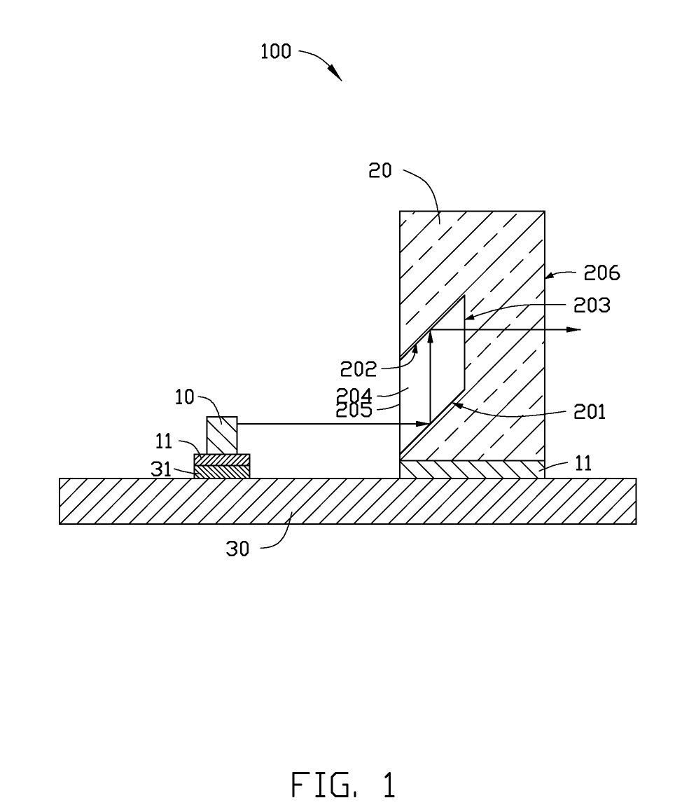

Referring to FIG. 1, a light source module 100 in accordance with a first embodiment is illustrated. The light source module 100 includes a laser light source 10, an optical lens 20 facing the laser light source 10, and a base 30 supporting the laser light source 10 and the optical lens 20. The optical lens 20 is used for adjusting light emitted from the laser light source 10.

A luminescence spectrum of the laser light source 10 is narrow, and the light emitted from the laser light source 10 is concentrated, whereby it is difficult to be intervened when it transmits through the air or other medium. The laser light source 10 mostly converts electric energy into optical energy, and hardly converts into heat energy, so the photoelectric conversion efficiency of the laser light source 10 is high.

The laser light source 10 is mounted on the base 30 via a fixing adhesive 11. The base 30 includes an electrical pad 31 supporting and electrically connecting to the laser light source 10.

The optical lens 20 is made of a material selected from a group consisting of polycarbonate (PC), polymethyl methacrylate (PMMA) and optical glass. The optical lens 20 is mounted on the base 30 also via a fixing adhesive 11. The optical lens 20 includes a first light reflecting face 201, a second light reflecting face 202 facing the first light reflecting face 201, a light incident face 203 connecting the first light reflecting face 201 and the second light reflecting face 202, and a light emitting face 206 opposite to the light incident face 203.

The first light reflecting face 201 is planar and inclined relative to a light path of the light emitted from the laser light source 10. In this embodiment of the present disclosure, an angle between the first light reflecting face 201 and the light path is equal to 45°. The second light reflecting face 202 is planar and parallel to the first light reflecting face 201. The second light reflecting face 202 is spaced from the first light reflecting face 201. The light incident face 203 is planar and perpendicular to the light path of the light emitted from the laser light source 10. The light emitting face 206 is planar and parallel to the light incident face 203.

The light emitted from the laser light source 10 is firstly reflected to the second reflecting face 202 by the first reflecting face 201, then reflected to the light incident face 203 by the second reflecting face 202, and then entered into the optical lens 20 from the light incident face 203, and transmitted in the optical lens 20, finally exited from the light emitting face 206. The light exited from the light emitting face 206 of the optical lens 20 extends along a same direction as the light emitted from the laser light source 10.

The first light reflecting face 201 cooperates with the second light reflecting face 202 and the light incident face 203 to define a cavity 204 having an opening 205 facing the laser light source 10.

It could be understood, a reflecting film (not shown) is further formed on the first/second reflecting face 201/202 by attachment, electroplating deposition, sputtering deposition or evaporation deposition. The reflecting film is made of material selected from gold, titanium, chrome, silver, aluminum, or an alloy thereof.

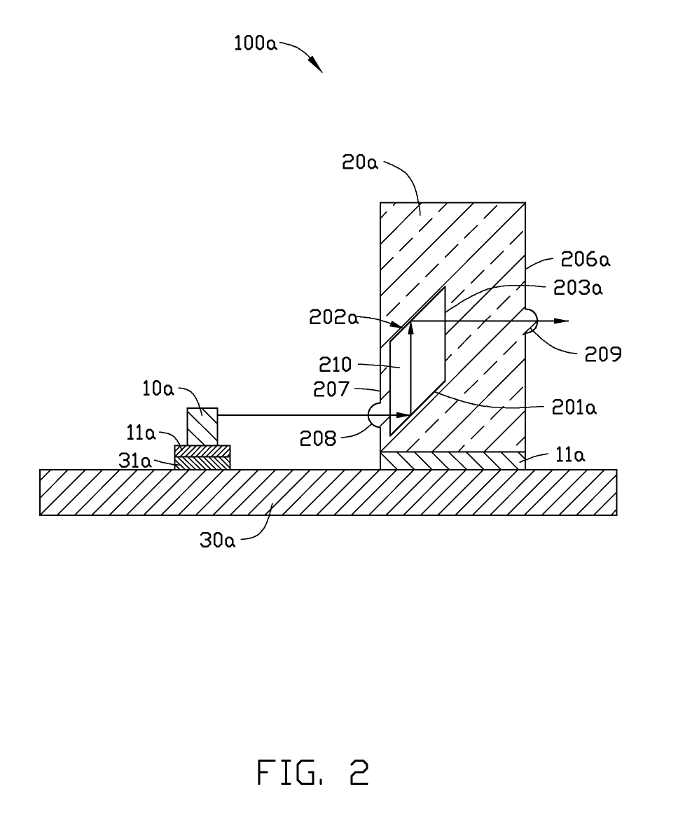

Referring to FIG. 2, a light source module 100a in accordance with a second embodiment is illustrated. The light source module 100a includes a laser light source 10a, an optical lens 20a facing the laser light source 10a, and a base 30a supporting the laser light source 10a and the optical lens 20a. The optical lens 20a is used for adjusting light emitted from the laser light source 10a.

A luminescence spectrum of the laser light source 10a is narrow, and the light emitted from the laser light source 10a is concentrated, whereby it is difficult to be intervened when it transmits through the air or other medium. The laser light source 10a mostly converts electric energy into optical energy, and hardly converts into heat energy, so the photoelectric conversion efficiency of the laser light source 10a is high.

The laser light source 10a is mounted on the base 30a via a fixing adhesive 11a. The base 30a includes an electrical pad 31a supporting and electrically connecting to the laser light source 10a.

The optical lens 20a is made of a material selected from a group consisting of polycarbonate (PC), polymethyl methacrylate (PMMA) and optical glass. The optical lens 20a is mounted on the base 30a also via a fixing adhesive 11a. The optical lens 20a includes a first light incident face 207, a first light reflecting face 201a, a second light reflecting face 202a facing the first light reflecting face 201a, a second light incident face 203a connecting the first light reflecting face 201a and the second light reflecting face 202a, and a light emitting face 206a opposite to the second light incident face 203a.

The first light reflecting face 201a is planar and inclined relative to a light path of the light emitted from the laser light source 10a. In this embodiment of the present disclosure, an angle between the first light reflecting face 201 a and the light path is equal to 45°. The second light reflecting face 202a is planar and parallel to the first light reflecting face 201a. The second light reflecting face 202a is spaced from the first light reflecting face 201a. The first light incident face 207 is planar and perpendicular to the light path of the light emitted from the laser light source 10a. The second light incident face 203a is planar and parallel to the first light incident face 207. The second light incident face 203a is spaced from the first light incident face 207. The light emitting face 206a is planar and parallel to the second light incident face 203a.

The optical lens 20 further includes a first convex portion 208 protruding outwardly from the first light incident face 207 towards the laser light source 10a, and a second convex portion 209 protruding outwardly from the light emitting face 206a.

The first light incident face 207 cooperates with the first light reflecting face 201a, the second light reflecting face 202a and the second light incident face 203a to define a room 210 inside of the optical lens 20a.

The light emitted from the laser light source 10a is firstly entered into the optical lens 20a from the first convex portion 208 and extended through the first light incident face 207, then reflected to the second reflecting face 202a by the first reflecting face 201a, then reflected to the second light incident face 203a by the second reflecting face 202a, and then extended through the second light incident face 203a and transmitted in the optical lens 20a, finally exited from the light emitting face 206a through the second convex portion 209. The light exited from the light emitting face 206a of the optical lens 20a extends along a same direction as the light emitted from the laser light source 10a.

It could be understood, a reflecting film (not shown) is further formed on the first/second reflecting face 201a/202a by attachment, electroplating deposition, sputtering deposition or evaporation deposition. The reflecting film is made of material selected from gold, titanium, chrome, silver, aluminum, or an alloy thereof.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A light source module, comprising:
a laser light source; and
an optical lens facing the laser light source, and the optical lens comprising a first light reflecting face, a second light reflecting face facing the first light reflecting face, a light incident face connecting the first light reflecting face and the second light reflecting face, and a light emitting face opposite to the light incident face;
wherein light emitted from the laser light source is firstly reflected to the second reflecting face by the first reflecting face, then reflected to the light incident face by the second reflecting face, and then entered into the optical lens from the light incident face, and transmitted in the optical lens, finally exited from the light emitting face.

2. The light source module of claim 1, wherein the first light reflecting face is planar and inclined relative to a light path of the light emitted from the laser light source.

3. The light source module of claim 2, wherein an angle between the first light reflecting face and the light path is equal to 45°.

4. The light source module of claim 2, wherein the second light reflecting face is planar and parallel to the first light reflecting face.

5. The light source module of claim 2, wherein the second light reflecting face is spaced from the first light reflecting face.

6. The light source module of claim 2, wherein the light incident face is planar and perpendicular to the light path of the light emitted from the laser light source.

7. The light source module of claim 1, wherein the light emitting face is planar and parallel to the light incident face.

8. The light source module of claim 1, wherein the first light reflecting face cooperates with the second light reflecting face and the light incident face to define a cavity having an opening facing the laser light source.

9. A light source module, comprising:
a laser light source; and
an optical lens facing the laser light source, and the optical lens comprising a first light incident face, a first light reflecting face, a second light reflecting face facing the first light reflecting face, a second light incident face connecting the first light reflecting face and the second light reflecting face, and a light emitting face opposite to the second light incident face;
wherein light emitted from the laser light source is firstly entered into the optical lens through the first light incident face, then reflected to the second reflecting face by the first reflecting face, then reflected to the second light incident face by the second reflecting face, and then extended through the second light incident face and transmitted in the optical lens, finally exited from the light emitting face.

10. The light source module of claim 9, wherein the optical lens further includes a first convex portion protruding outwardly from the first light incident face towards the laser light source.

11. The light source module of claim 10, wherein the light emitted from the laser light source is entered into optical lens through the first convex portion.

12. The light source module of claim 9, wherein the optical lens further includes a second convex portion protruding outwardly from the light emitting face.

13. The light source module of claim 12, wherein the light is exited from the optical lens through the second convex portion.

14. The light source module of claim 9, wherein the first light incident face is spaced from and parallel to the second light incident face.

15. The light source module of claim 9, wherein the first light incident face is perpendicular to a light path of the light emitted from the laser light source.

16. The light source module of claim 9, wherein the first light reflecting face is spaced from and parallel to the second light reflecting face.

17. The light source module of claim 16, wherein the first light reflecting face is planar and inclined relative to a light path of the light emitted from the laser light source.

18. The light source module of claim 9, wherein the light emitting face is parallel to the second light incident face.

19. The light source module of claim 9, wherein the first light incident face cooperates with the first light reflecting face, the second light reflecting face and the second light incident face to define a room inside of the optical lens.

20. The light source module of claim 9, further comprising a base supporting the optical lens and the laser light source.
